(19) United States
(12) Patent Application Publication
(10) Pub. No.: US 2018/0060859 A1
(43) Pub. Date: Mar. 1, 2018

(54) SYSTEM AND METHOD FOR TRIGGERING AN ELECTRONIC PAYMENT BETWEEN A FIRST ENTITY AND A SECOND ENTITY

(71) Applicant: MasterCard Asia/Pacific Pte. Ltd., Singapore (SG)

(72) Inventors: Benjamin Charles Gilbey, Sinagpore (SG); Vijin Venugopalan, Singapore (SG); Saurav Ray, Singapore (SG)

(21) Appl. No.: 15/684,032

(22) Filed: Aug. 23, 2017

(30) Foreign Application Priority Data
Aug. 23, 2016 (SG) 10201607027U

(51) Int. Cl. G06Q 20/36; H04L 29/08; G06Q 30/06

(52) U.S. Cl. CPC G06Q 20/3674; G06Q 30/06; H04L 67/306

(57) ABSTRACT

There is provided a system and method for triggering an electronic payment between a first entity and a second entity. The system and method can also be for triggering an electronic payment for a first entity. It should be noted that the system and method can aid individuals to adopt desirable behavioural traits or give up undesirable habits.

### TECHNICAL FIELD

The present invention relates to a system and method for either rewarding or penalising an entity via electronic payments.

### BACKGROUND

Behavioural economics is regularly used by government authorities to discourage perceived undesirable activities, such as, for example, smoking, consumption of sugar, gambling, and so forth. It should be noted that the converse is also carried out to encourage perceived desirable activities, such as, for example, parenthood incentives, recycling incentives, and the like.

On a micro level, there are some households that incentivise children in the course of shaping the mindsets of the children. For example, parents may provide a “playground pass” for a child who helps with housework, additional pocket money for a child who eats vegetables provided to the child and so forth. Conversely, parents may also punish their child for not sleeping by a stipulated time, not cleaning up after playtime, and so forth.

Generally, incentivising/penalising an individual in order to cultivate/discourage a particular behaviour for the individual has been carried out at various levels as described in the preceding paragraphs.

Unfortunately, targeted incentivising/penalising of the individual when in situations of a macro scale is not available.

### SUMMARY

There is provided a system for triggering an electronic payment between a first entity and a second entity. The system comprises: a first computing device configured for recording first parameters of the first entity; a second computing device configured for inputting second parameters from the second entity; at least one assessment server communicatively coupled to both the first and the second computing device, the at least one assessment server being configured to provide a comparative result by processing the first parameters received from the first computing device and the second parameters received from the second computing device; and a digital wallet profile associated with the first entity. It is preferable that the comparative result determines the triggering of the electronic payment at the digital wallet profile.

There is also provided a system for triggering an electronic payment for a first entity, the system comprising: at least one computing device configured for determining first parameters of the first entity, and for inputting second parameters from the first entity; at least one assessment server communicatively coupled to the at least one computing device, the at least one assessment server being configured to provide a comparative result by processing the first parameters and the second parameters; and a digital wallet profile associated with the first entity. It is preferable that the comparative result determines the triggering of the electronic payment at the digital wallet profile.

Preferably, the at least one assessment server is configured to associate the first parameters with the second parameters.

The first parameters can include at least one of, for example: location data of the first entity; duration data for each location accessed by the first entity; payment data for payments made by the first entity; exercise data for number of calories burnt by the first entity; exercise data for extended duration of increased heart rate of the first entity and so forth.

The second parameters can include at least one of, for example: at least one desired location for the first entity; at least one desired duration that the first entity is present at the at least one desired location; at least one item that the first entity should desirably purchase; at least one pre-determined quantum for the calories burnt by the first entity; at least one pre-determined duration for increased heart rate by the first entity; at least one undesirable location for the first entity; at least one undesirable duration that the first entity is present at the at least one undesirable location; at least one item that the first entity should not purchase and so forth.

It is preferable that the at least one assessment server is configured to compare the first parameters, or quantities derived therefrom, with the second parameters, or quantities derived therefrom, to obtain the result, the result being either positive or negative. The positive result can obtained if, for example, the first entity was at a desired location for a desired duration, the first entity made a desirable purchase, the first entity burnt a pre-determined number of calories, or the first entity experienced an extended period of increased heart rate. Alternatively, the negative result is obtained if, for example, the first entity was at an undesirable location for an undesirable duration, or the first entity made an undesirable purchase.

It is preferable that the balance increases when the positive result is obtained, while the balance decreases when the negative result is obtained. It is also preferable that the second entity is a sponsor for the first entity.

There is also provided a server configured for triggering an electronic payment between a first entity and a second entity, the server being configured to carry out a method embodied in: receiving first parameters from a first computing device of the first entity; receiving second parameters from a second computing device of the second entity; processing the first parameters, or quantities derived therefrom, and the second parameters, or quantities derived therefrom, to determine a comparative result; and transmitting instructions affecting a balance of a digital wallet profile associated with the first entity. It is preferable that the comparative result determines the triggering of the electronic payment at the digital wallet profile.

There is also a server configured for triggering an electronic payment for a first entity, the server being configured to carry out a method embodied in: receiving first parameters and second parameters from a computing device of the first entity; processing the first parameters, or quantities derived therefrom, and the second parameters, or quantities derived therefrom, to determine a comparative result; and transmitting instructions affecting a balance of a digital wallet profile associated with the first entity. Preferably, the comparative result determines the triggering of the electronic payment at the digital wallet profile.

The server can further comprise carrying out a step embodied in associating the first parameters with the second parameters.

It is preferable that the first parameters include at least one of, for example: location data of the first entity; duration data for each location accessed by the first entity; payment data for payments made by the first entity; exercise data for number of calories burnt by the first entity; exercise data for extended duration of increased heart rate of the first entity and so forth.

It is also preferable that the second parameters include at least one of, for example: at least one desired location for the first entity; at least one desired duration that the first entity is present at the at least one desired location; at least one item that the first entity should desirably purchase; at least one pre-determined quantum for the calories burnt by the first entity; at least one pre-determined duration for increased heart rate by the first entity; at least one undesirable location for the first entity; at least one undesirable duration that the first entity is present at the at least one undesirable location; at least one item that the first entity should not purchase, and so forth.

Preferably, the comparative result is either positive or negative. The positive result can be obtained if, for example, the first entity was at a desired location for a desired duration, and the first entity made a desirable purchase, the first entity burnt a pre-determined number of calories, or the first entity experienced an extended period of increased heart rate. Alternatively, the negative result is obtained if, for example, the first entity was at an undesirable location for an undesirable duration, or the first entity made an undesirable purchase.

It is preferable that the balance in the digital wallet profile increases when the positive result is obtained, while the balance in the digital wallet profile decreases when the negative result is obtained.

The instructions are preferably either sent to a third party server to credit the digital wallet profile or sent to the digital wallet profile to credit the third party server. The second entity can be a sponsor for the first entity.

In another aspect, there is provided a non-transitory computer readable storage medium embodying thereon a program of computer readable instructions which, when executed by one or more processors of a server in communication with at least one computing device, cause the server to perform a method for triggering an electronic payment between a first entity and a second entity. The method embodies the steps of: receiving first parameters from a first computing device of the first entity; receiving second parameters from a second computing device of the second entity; processing the first parameters, or quantities derived therefrom, and the second parameters, or quantities derived therefrom, to determine a comparative result, and transmitting instructions affecting a balance of a digital wallet profile associated with the first entity. Preferably, the comparative result determines the triggering of the electronic payment at the digital wallet profile.

There is also provided a non-transitory computer readable storage medium embodying thereon a program of computer readable instructions which, when executed by one or more processors of a server in communication with at least one computing device, cause the server to perform a method for triggering an electronic payment for a first entity. The method embodies the steps of: receiving first parameters and second parameters from a computing device; processing the first parameters, or quantities derived therefrom, and the second parameters, or quantities derived therefrom, to determine a comparative result; and transmitting instructions affecting a balance of a digital wallet profile associated with the first entity. It is preferable that the comparative result determines the triggering of the electronic payment at the digital wallet profile.

The storage medium can further include carrying out a step embodied in associating the first parameters with the second parameters.

It is preferable that the first parameters include at least one of, for example, location data of the first entity; duration data for each location accessed by the first entity; payment data for payments made by the first entity; exercise data for number of calories burnt by the first entity; exercise data for extended duration of increased heart rate of the first entity, and so forth. It is also preferable that the second parameters include at least one of, for example, at least one desired location for the first entity; at least one desired duration that the first entity is present at the at least one desired location; at least one item that the first entity should desirably purchase; at least one pre-determined quantum for the calories burnt by the first entity; at least one pre-determined duration for increased heart rate by the first entity; at least one undesirable location for the first entity; at least one undesirable duration that the first entity is present at the at least one undesirable location; at least one item that the first entity should not purchase and so forth.

Preferably, the comparative result is either positive or negative. The positive result is obtained if, for example, the first entity was at a desired location for a desired duration, the first entity made a desirable purchase, the first entity burnt a pre-determined number of calories, or the first entity experienced an extended period of increased heart rate. The negative result is obtained if, for example, the first entity was at an undesirable location for an undesirable duration, or the first entity made an undesirable purchase.

It is preferable that the balance in the digital wallet profile increases when the positive result is obtained, and the balance in the digital wallet profile decreases when the negative result is obtained.

The instructions can be either sent to a third party server to credit the digital wallet profile or sent to the digital wallet profile to credit the third party server.

It is preferable that the second entity is a sponsor for the first entity.

In another aspect, there is provided a data processor implemented method for triggering an electronic payment between a first entity and a second entity, the method comprising: receiving first parameters from a first computing device of the first entity; receiving second parameters from a second computing device of the second entity; processing the first parameters or quantities derived therefrom, and the second parameters or quantities derived therefrom, to determine a comparative result; and transmitting instructions affecting a balance of a digital wallet profile associated with the first entity. It is preferable that the comparative result determines the triggering of the electronic payment at the digital wallet profile.

There is also provided a data processor implemented method for triggering an electronic payment for a first entity, the method comprising: receiving first parameters and second parameters from a computing device; processing the first parameters, or quantities derived therefrom, and the second parameters, or quantities derived therefrom, to determine a comparative result; and transmitting instructions affecting a balance of a digital wallet profile associated with the first entity. Preferably, the comparative result determines the triggering of the electronic payment at the digital wallet profile.

The method can further include associating the first parameters with the second parameters.

It is preferable that the first parameters include at least one of, for example: location data of the first entity; duration data for each location accessed by the first entity; payment data for payments made by the first entity; exercise data for number of calories burnt by the first entity; exercise data for extended duration of increased heart rate of the first entity and so forth.

The second parameters can preferably include at least one of, for example: at least one desired location for the first entity; at least one desired duration that the first entity is present at the at least one desired location; at least one item that the first entity should desirably purchase; at least one pre-determined quantum for the calories burnt by the first entity; at least one pre-determined duration for increased heart rate by the first entity; at least one undesirable location for the first entity; at least one undesirable duration that the first entity is present at the at least one undesirable location; at least one item that the first entity should not purchase, and so forth.

It is preferable that the comparative result is either positive or negative. The positive result is obtained if, for example, the first entity was at a desired location for a desired duration, and the first entity made a desirable purchase, the first entity burnt a pre-determined number of calories, or the first entity experienced an extended period of increased heart rate. The negative result is obtained if, for example, the first entity was at an undesirable location for an undesirable duration, or the first entity made an undesirable purchase.

Preferably, the balance in the digital wallet profile increases when the positive result is obtained, while the balance in the digital wallet profile decreases when the negative result is obtained.

The instructions are preferably either sent to a third party server to credit the digital wallet profile or sent to the digital wallet profile to credit the third party server. The second entity can be a sponsor for the first entity.

### DESCRIPTION OF FIGURES

In order that the present invention may be fully understood and readily put into practical effect, there shall now be described, by way of non-limitative example only certain embodiments of the present invention, the description being with reference to the accompanying illustrative figures, in which:

FIG. 1 shows an overview of a system according to some embodiments of the present invention;

FIG. 2 shows a process flow of a method according to some embodiments of the present invention;

FIG. 3 shows a schematic view of a user device used in the system and method of the present invention;

FIG. 4 shows a schematic view of a server used in the method shown in FIG. 2; and

FIG. 5 shows a block diagram of a personal payments system provided in accordance with aspects of the present invention.

### DETAILED DESCRIPTION

There is provided a method, and system for triggering an electronic payment for/to an entity. In at least some embodiments, the method, and system enables users to be financially incentivised/penalised, depending on the choices made by the users or depending on activities carried out by the users. In addition, the method, and system can aid users in adopting desirable behavioural traits or giving up undesirable habits.

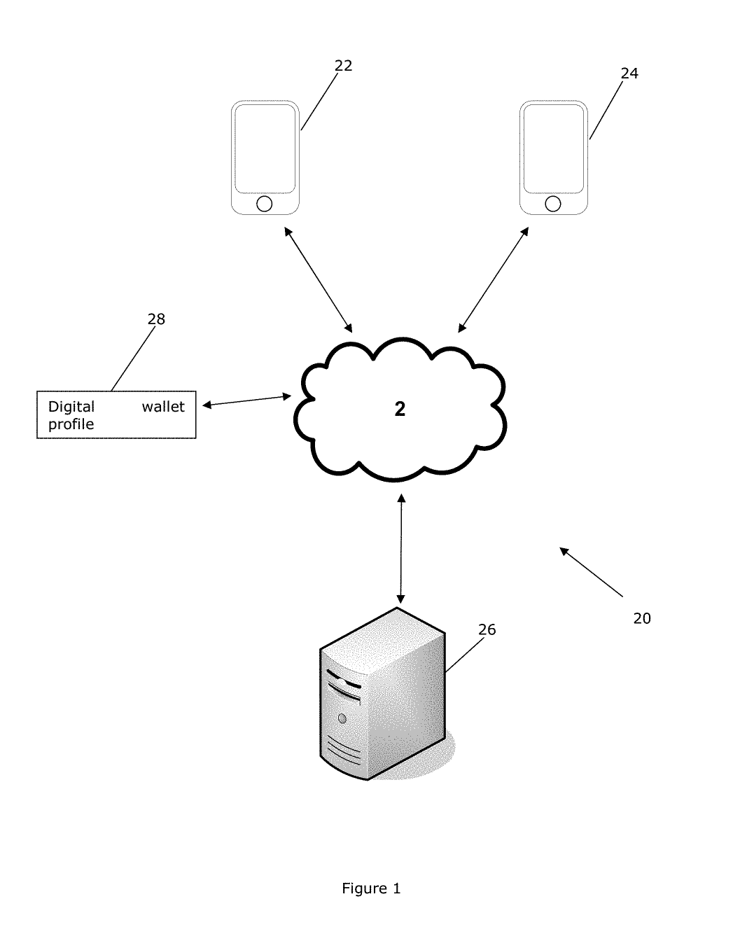

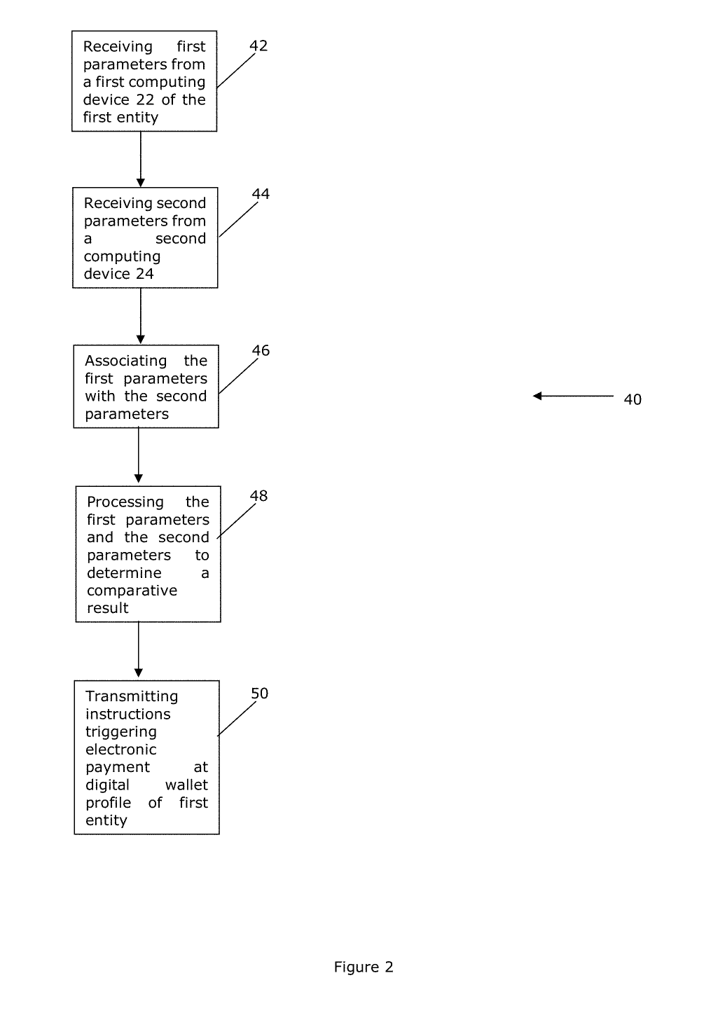

FIG. 2 shows the steps of an exemplary method 40, while FIG. 1 shows a possible system 20 in which the steps are carried out. The method 40 is depicted in a flow diagram, where each of the blocks of the flow diagram may be executed by a data processor(s) or a portion of the data processor (for example, a single core of a multi-core processor). The processes may be embodied in a non-transient machine-readable and/or computer-readable medium for configuring a computer system to execute the method. A software module(s) may be stored within and/or transmitted to a computer system memory to configure the computer system to carry out the tasks indicated in each of the blocks of the flow diagram.

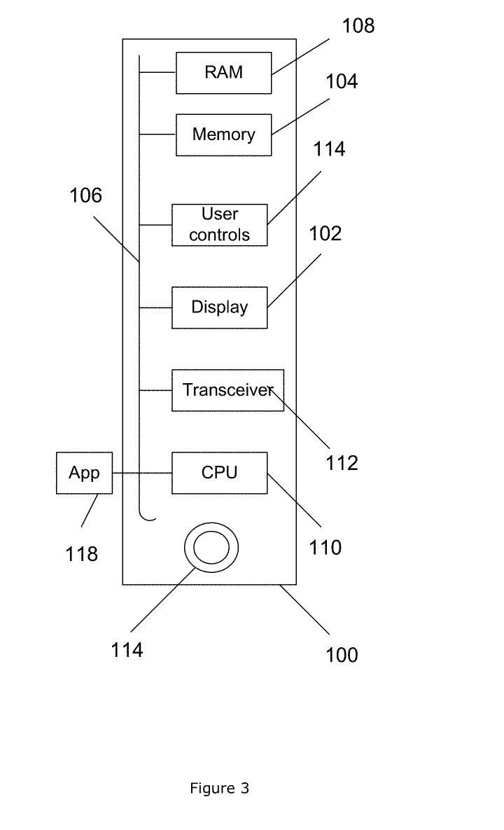

In the system 20, each computing device 22, 24 can be a mobile device 100. An exemplary embodiment of the mobile device 100 is shown in FIG. 3. The mobile device 100 is a handheld device such as a smartphone or a tablet computer such as one manufactured by Apple™, LG™, HTC™, Samsung™, and Motorola™. As shown, the device 100 includes the following components in electronic communication via a bus 106:
a display 102;
non-volatile memory 104;
random access memory (“RAM”) 108;
N processing components 110;
a transceiver component 112 that includes N transceivers; and
user controls 114.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 102 generally operates to provide a presentation of content to a user, and may be realized by any of a variety of displays (e.g., CRT, LCD, HDMI, micro-projector and OLED displays). And in general, the non-volatile memory 104 functions to store (e.g. persistently store) data and executable code including code that is associated with the functional components of the method. In some embodiments, for example, the non-volatile memory 104 includes bootloader code, modem software, operating system code, file system code, and code to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

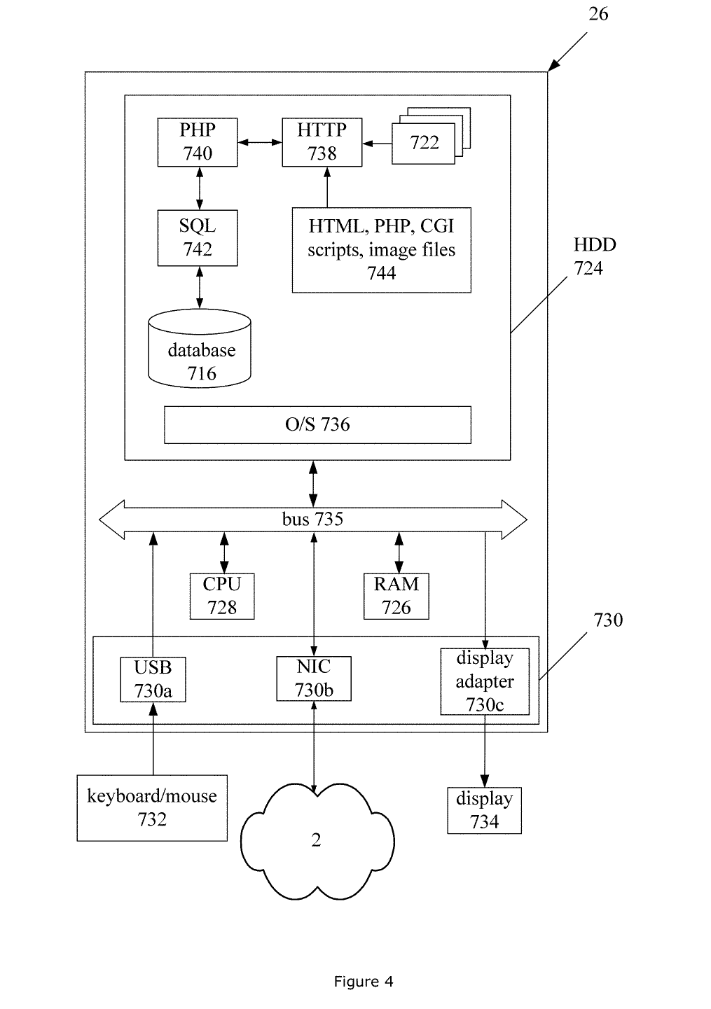

The method 40 can also be carried out by a server 26 as shown in FIGS. 1 and 4. The server 26 is able to communicate with the mobile device 100 over a communications network 2 using standard communication protocols.

It should be appreciated that the method 40 can be configured to be performed in a variety of ways. The steps can be implemented entirely by software to be executed on standard computer server hardware, which may comprise one hardware unit or different computer hardware units distributed over various locations, some of which may require the communications network 2 for communication. A number of the components or parts thereof may also be implemented by application specific integrated circuits (ASICs) or field programmable gate arrays.

In FIG. 4, the server 26 is a commercially available server computer system based on a 32 bit or a 64 bit Intel architecture, and the processes and/or methods executed or performed by the computer server 26 are implemented in the form of programming instructions of one or more software components or modules 722 stored on non-volatile (e.g., hard disk) computer-readable storage 724 associated with the server 26. At least parts of the software modules 722 could alternatively be implemented as one or more dedicated hardware components, such as application-specific integrated circuits (ASICs) and/or field programmable gate arrays (FPGAs).

The server 26 includes at least one or more of the following standard, commercially available, computer components, all interconnected by a bus 735:
1. random access memory (RAM) 726;
2. at least one computer processor 728, and
3. external computer interfaces 730:
   a. universal serial bus (USB) interfaces 730a (at least one of which is connected to one or more user-interface devices, such as a keyboard, a pointing device (e.g., a mouse 732 or touchpad),
   b. a network interface connector (NIC) 730b which connects the
   c. a display adapter 730c, which is connected to a display device 734 such as a liquid-crystal display (LCD) panel device.

The server 26 includes a plurality of standard software modules, including:
1. an operating system (OS) 736 (e.g., Linux or Microsoft Windows);
2. web server software 738 (e.g., Apache, available at http://www.apache.org);
3. scripting language modules 740 (e.g., personal home page or PHP, available at http://www.php.net, or Microsoft ASP); and
4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 26 with the general ability to allow users of the Internet 2 with mobile device 100 to access the server 26, for example using standard web browser software, and in particular to provide data to and receive data from the database 716. It will be understood by those skilled in the art that the specific functionality provided by the server 26 to such users may be provided by scripts accessible by the web server 738, including the one or more software modules 722 implementing the processes performed by the server 26, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 26 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 26 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Referring to FIG. 1, there is provide a possible embodiment of a system 20 for providing an outcome to a first entity via electronic payments. The various components of the system 20 are communicatively coupled via the network 2. The system 20 comprises a first computing device 22 configured for recording first parameters of the first entity. The first computing device 22 can be like the mobile device 100, preferably always being in close proximity with the first entity such that the first parameters are accurate. The first parameters can include, for example, location data (positional coordinates) of the first entity, duration data for each location accessed by the first entity, payment data for payments made by the first entity, and other information relating to movements/activities carried out by the first entity like an increase in heart rate over an extended period, number of calories burnt and so forth. It should be appreciated that the first parameters are obtained by sensors on the first computing device 22, such as, for example, a positioning module, a payments module, a pedometer, a wireless transceiver (for checking in at a venue), a heart rate monitor, a calorie counter and so forth.

The system 20 also includes a second computing device 24 configured for inputting second parameters from a second entity. The second computing device 22 can also be like the mobile device 100. The second parameters can include at least one of, for example, at least one desired location for the first entity, at least one desired duration that the first entity is present at the at least one desired location, at least one item that the first entity should desirably purchase, at least one undesirable location for the first entity, at least one pre-determined quantum for the calories burnt by the first entity, at least one pre-determined duration for increased heart rate by the first entity, at least one undesirable duration that the first entity is present at the at least one undesirable location, at least one item that the first entity should not purchase and other information relating to desirable or undesirable movements/activities carried out by the first entity.

There is also at least one assessment server 26 communicatively coupled to both the first 22 and the second 24 computing device (via the network 2). The at least one assessment server 26 is configured to obtain a comparative result by processing the first parameters or quantities derived therefrom, received from the first computing device 22 and the second parameters or quantities derived therefrom, received from the second computing device 24. The at least one assessment server 26 is configured to associate the first parameters with the second parameters, in a manner where both sets of parameters pertain to the first entity only. The at least one assessment server 26 is also configured to compare the first parameters with the second parameters to obtain the comparative result, the result being either positive or negative. For example, the positive result is obtained during at least one situation such as, the first entity being at a desired location for a desired duration, the first entity making a desirable purchase and other desirable movements/activities carried out by the first entity. Similarly, the negative result is obtained during at least one situation such as, the first entity being at an undesirable location for an undesirable duration, the first entity making an undesirable purchase, and other undesirable movements/activities carried out by the first entity. Comparing both sets of parameters involve, for example, whether or not there are matches between the first and second parameters, whether the first parameters exceed a threshold(s) of the second parameters, whether the first parameters fall within a threshold of the second parameters and the like.

A digital wallet profile 28 associated with the first entity using, for example, by user ID, user mobile number, user email and so forth is also included in the system 20. Typically, the digital wallet profile 28 stores and/or generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard). The merchant system then submits an authorization request to, for example, a payment service provider (PSP) or the merchant's acquirer in known manner. It is appreciated that suitable known methods of conducting secure electronic commerce transactions can be employed.

In the system 20, the result determines an outcome received by the first entity. The outcome involves a balance at the digital wallet profile 28, whereby the first entity receives a financial incentive (increase in the balance) when the positive result is obtained and receives a financial penalty (decrease in the balance) when the negative result is obtained. Thus, the first entity will be motivated to obtain more positive results (by carrying out more desirable activities/movements) to receive more financial incentives and to minimise negative results (by minimising undesirable activities/movements) to minimise the financial penalties. It should be appreciated that in the preceding description, a second entity is involved to help to improve the lifestyle of the first entity. For example, the second entity can be a sponsor(s) of the first entity. The sponsor(s) can be, for example, friends, family, government agencies and so forth. The second entity may be paying out to the first entity when the positive result occurs, and may be recipients of monies from the first entity when the negative result occurs. It should also be appreciated that the first entity is regularly informed of the movement of monies at the digital wallet profile 28 so that the first entity is always able to adjust their movements/activities to best benefit the balance at their digital wallet profile 28.

In another embodiment of the system 20, the first entity can rely on the system 20 for self-improvement of lifestyle. In such a scenario, the first entity uses the first computing device 22 to input the second parameters of their own preference. Thus, it should be noted that the first computing device 22 can also be used to input the second parameters (regardless of whether it is by the first entity or not). In such a scenario, for example, the first entity can be paid by a trust fund (which would otherwise not have accessible monies) when the positive result occurs, and can pay out to a charitable organisation when the negative result occurs.

Further details will now be provided for processes carried out in the server 26 when the server 26 is part of the system 20 or similar. Referring to FIG. 2, there is shown a data processor implemented method 40 for providing an outcome to a first entity via electronic payments. The server 26 can be configured to carry out the method 40. Reference will also be made to FIG. 1 for labelling of the respective components. The method 40 comprises receiving first parameters from the first computing device 22 (42). The first parameters can include, for example, location data (positional coordinates) of the first entity, duration data for each location accessed by the first entity, payment data for payments made by the first entity, and other information relating to movements/activities carried out by the first entity like an increase in heart rate over an extended period, number of calories burnt and so forth. It should be appreciated that the first parameters are obtained by sensors on the first computing device 22, such as, for example, a positioning module, a payments module, a pedometer, a wireless transceiver (for checking in at a venue) and so forth.

Subsequently, second parameters are received from the second computing device 24 (44). The second parameters can include at least one of, for example, at least one desired location for the first entity, at least one desired duration that the first entity is present at the at least one desired location, at least one item that the first entity should desirably purchase, at least one pre-determined quantum for the calories burnt by the first entity, at least one pre-determined duration for increased heart rate by the first entity, at least one undesirable location for the first entity, at least one undesirable duration that the first entity is present at the at least one undesirable location, at least one item that the first entity should not purchase and other information relating to desirable or undesirable movements/activities carried out by the first entity. The first parameters are then associated with the second parameters (46), in a manner where both sets of parameters pertain to the first entity only.

The first parameters and the second parameters are then processed to determine a comparative result (48), whereby the processing involves, for example, whether or not there are matches between the first and second parameters, whether the first parameters exceed a threshold(s) of the second parameters, whether the first parameters fall within a threshold of the second parameters and the like. The result can be either positive or negative. For example, the positive result is obtained during at least one situation such as, the first entity being at a desired location for a desired duration, the first entity making a desirable purchase and other desirable movements/activities carried out by the first entity. Similarly, the negative result is obtained during at least one situation such as, the first entity being at an undesirable location for an undesirable duration, the first entity making an undesirable purchase, and other undesirable movements/activities carried out by the first entity.

Next, instructions affecting a balance of the digital wallet profile 28 associated with the first entity to move monies at the digital wallet profile 28 are transmitted (50) to either a third party server to credit the digital wallet profile 28 or to the digital wallet profile 28 to credit the third party server. It should be appreciated that the result determines the outcome received by the first entity, the outcome involving a balance at the digital wallet profile 28. The first entity receives a financial incentive (increase in the balance) when the positive result is obtained and receives a financial penalty (decrease in the balance) when the negative result is obtained. Thus, the first entity will be motivated to obtain more positive results (by carrying out more desirable activities/movements) to receive more financial incentives and to minimise negative results (by minimising undesirable activities/movements) to minimise the financial penalties. It should be appreciated that in the preceding description, a second entity is involved to help to improve the lifestyle of the first entity. For example, the second entity can be a sponsor of the first entity, whereby the sponsor can include, for example, friends, family, government and so forth. The second entity can be associated with the third party server and may be paying out to the first entity when the positive result occurs, and may be recipients of monies from the first entity when the negative result occurs. It should also be appreciated that the first entity is regularly informed of the movement of monies at the digital wallet profile 28 so that the first entity is always able to adjust their movements/activities to best benefit a balance at their digital wallet profile 28.

Generally, when the first entity is being rewarded with a predetermined quantum of money, payment is made from the second entity to the digital wallet profile 28 associated with the first entity. It should be appreciated that there can be more than a single second entity. Each second entity can, for example, have a mobile app paired with each of the second entity's payment instrument, and each of the second entity's payment instrument can be charged with the predetermined quantum of money. The predetermined quantum of money can be transferred to the digital wallet profile 28 associated with the first entity or to an escrow account for later crediting to the first entity, Conversely, when the first entity is penalised, payment is made from the digital wallet profile 28 associated with the first entity, whereby the payment can be a wallet-to-wallet transfer or a wallet-to-account transfer. It should be appreciated that the second entity need not receive the payment, and instead, the payment can be diverted to an account/wallet associated with an ID of a charitable organisation.

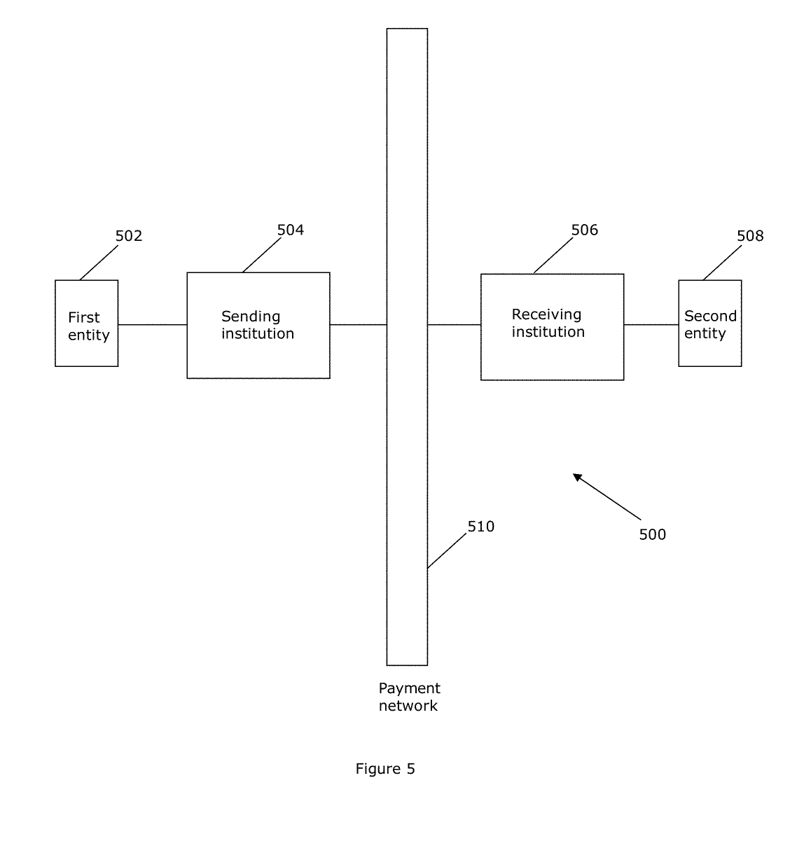

FIG. 5 is a block diagram that presents a view of a personal payments system 500, particularly within the context of a single payment transaction such as transactions between the first entity and the second entity.

A first entity 502 wishing to make a particular payment transaction to a second entity 508 may interact with his/her service provider (the “sending institution” or “payment originator”) 504 to request that the transaction take place. The sending institution 504 may route the transaction via the payment network 510 to the service provider (the “receiving institution”) 506 for the second entity 508. The receiving institution 506 may inform the second entity 508 that the payment transaction has taken place.

Typically, the sending 504 and receiving 506 institutions are financial institutions (FIs). However, this need not necessarily be the case. For example, either or both of the sending institution and the receiving institution may be non-FI service providers. In such situations it will often be the case that an FI is associated in the background with the non-FI service provider to facilitate connectivity to the payment network 510.

In some embodiments, the first entity 502 may make the initial request for a payment transaction to a non-FI service provider (not shown in FIG. 5), which will then forward the request to the sending institution 504.

While not shown in FIG. 5, other entities or devices may also participate in the system 500. For example, a service provider offering payment services may be involved in some transactions or systems. The service provider may facilitate transactions between the first entity 502 and the sending institution 504. Other service providers may also be involved in some embodiments.

Further example implementations of personal payment transactions are provided in the following published US patent applications:
US 2008/0249929 titled “Payment Card Based Remittance System With Delivery Of Anti-Money Laundering Information To Originating Financial Institution”;
US 2008/0249935 titled “Methods And Apparatus For Funds Remittances To Non-Payment Card Accounts Using Payment Card System”; and
US 2015/0363752 titled “Payment Network With Service Provider Directory Function”.

Relevant disclosure from the aforementioned documents in relation to the carrying out of personal payment transactions are incorporated herein by reference.

In another embodiment of the method 40, the first entity can also carry out self-improvement of lifestyle. In such a scenario, the first entity uses the first computing device 22 to input the second parameters of their own preference. Basically, step 44 changes in a manner where the second parameters are received from the first computing device 22. Thus, it should be noted that the first computing device 22 can also be used to input the second parameters (regardless of whether it is by the first entity or not). In such a scenario, for example, the first entity can be paid by a trust fund (which would otherwise not have accessible monies) when the positive result occurs, and can pay out to a charitable organisation when the negative result occurs.

In view of the preceding description, it should be noted that there is a method 40, server 26 and system 20 for triggering an electronic payment to/from an entity. The method 40, server 26 and system 20 can be helpful aids in providing targeted incentivising/penalising practices/behaviour of an individual on a macro scale, easily across any country or anywhere in the world. This can be carried out regardless of where the individual is at any juncture, and can aid the individuals to adopt desirable behavioural traits or give up undesirable habits.

Whilst there have been described in the foregoing description preferred embodiments of the present invention, it will be understood by those skilled in the technology concerned that many variations or modifications in details of design or construction may be made without departing from the present invention.

1. A system for triggering an electronic payment between a first entity and a second entity, the system comprising:
a first computing device configured for recording first parameters of the first entity;
a second computing device configured for inputting second parameters from the second entity;
at least one assessment server communicatively coupled to both the first and the second computing device, the at least one assessment server being configured to provide a comparative result by processing the first parameters received from the first computing device and the second parameters received from the second computing device; and
a digital wallet profile associated with the first entity,
wherein the comparative result determines the triggering of the electronic payment at the digital wallet profile.

2. (canceled)

3. The system of claim 1, wherein the at least one assessment server is configured to associate the first parameters with the second parameters.

4. The system of claim 1, wherein the first parameters include at least one of:
location data of the first entity;
duration data for each location accessed by the first entity;
payment data for payments made by the first entity;
exercise data for number of calories burnt by the first entity; and
exercise data for extended duration of increased heart rate of the first entity, and
wherein the second parameters include at least one of:
at least one desired location for the first entity;
at least one desired duration that the first entity is present at the at least one desired location;
at least one item that the first entity should desirably purchase;
at least one pre-determined quantum for the calories burnt by the first entity;
at least one pre-determined duration for increased heart rate by the first entity;
at least one undesirable location for the first entity;
at least one undesirable duration that the first entity is present at the at least one undesirable location; and
at least one item that the first entity should not purchase.

5. The system of claim 1, wherein the at least one assessment server is configured to compare the first parameters, or quantities derived therefrom, with the second parameters, or quantities derived therefrom, to obtain the result, the result being either positive or negative.

6. The system of claim 5, wherein the positive result is obtained if: the first entity was at a desired location for a desired duration, the first entity made a desirable purchase, the first entity burnt a pre-determined number of calories, or the first entity experienced an extended period of increased heart rate, and wherein the negative result is obtained if: the first entity was at an undesirable location for an undesirable duration, or the first entity made an undesirable purchase.

7. The system of claim 5, wherein the balance increases when the positive result is obtained, wherein the balance decreases when the negative result is obtained.

8. A server configured for triggering an electronic payment between a first entity and a second entity, the server being configured to carry out a method embodied in:
receiving first parameters from a first computing device of the first entity;
receiving second parameters from a second computing device of the second entity;
processing the first parameters, or quantities derived therefrom, and the second parameters, or quantities derived therefrom, to determine a comparative result; and
transmitting instructions affecting a balance of a digital wallet profile associated with the first entity,
wherein the comparative result determines the triggering of the electronic payment at the digital wallet profile.

9. (canceled)

10. The server of claim 8, further comprising carrying out a step embodied in associating the first parameters with the second parameters.

11. The server of claim 8, wherein the first parameters include at least one of:
location data of the first entity;
duration data for each location accessed by the first entity;
payment data for payments made by the first entity;
exercise data for number of calories burnt by the first entity; and
exercise data for extended duration of increased heart rate of the first entity, and
wherein the second parameters include at least one of:
at least one desired location for the first entity;
at least one desired duration that the first entity is present at the at least one desired location;
at least one item that the first entity should desirably purchase;
at least one pre-determined quantum for the calories burnt by the first entity;
at least one pre-determined duration for increased heart rate by the first entity;
at least one undesirable location for the first entity;
at least one undesirable duration that the first entity is present at the at least one undesirable location; and
at least one item that the first entity should not purchase.

12. The server of claim 8, wherein the comparative result is either positive or negative.

13. The server of claim 12, wherein the positive result is obtained if: the first entity was at a desired location for a desired duration, and the first entity made a desirable purchase, the first entity burnt a pre-determined number of calories, or the first entity experienced an extended period of increased heart rate, and wherein the negative result is obtained if: the first entity was at an undesirable location for an undesirable duration, or the first entity made an undesirable purchase.

14. The server of claim 12, wherein the balance in the digital wallet profile increases when the positive result is obtained, and wherein the balance in the digital wallet profile decreases when the negative result is obtained.

15. The server of claim 8, wherein the instructions are either sent to a third party server to credit the digital wallet profile or sent to the digital wallet profile to credit the third party server.

16. A non-transitory computer readable storage medium embodying thereon a program of computer readable instructions which, when executed by one or more processors of a server in communication with at least one computing device, cause the server to perform a method for triggering an electronic payment between a first entity and a second entity, the method embodying the steps of:
receiving first parameters from a first computing device of the first entity;
receiving second parameters from a second computing device of the second entity;
processing the first parameters, or quantities derived therefrom, and the second parameters, or quantities derived therefrom, to determine a comparative result, and
transmitting instructions affecting a balance of a digital wallet profile associated with the first entity,
wherein the comparative result determines the triggering of the electronic payment at the digital wallet profile.

17. (canceled)

18. The storage medium of claim 16, further including carrying out a step embodied in associating the first parameters with the second parameters.

19. The storage medium of claim 16, wherein the first parameters include at least one of:
location data of the first entity;
duration data for each location accessed by the first entity;
payment data for payments made by the first entity;
exercise data for number of calories burnt by the first entity; and
exercise data for extended duration of increased heart rate of the first entity, and
wherein the second parameters include at least one of:
at least one desired location for the first entity;
at least one desired duration that the first entity is present at the at least one desired location;
at least one item that the first entity should desirably purchase;
at least one pre-determined quantum for the calories burnt by the first entity;
at least one pre-determined duration for increased heart rate by the first entity;
at least one undesirable location for the first entity;
at least one undesirable duration that the first entity is present at the at least one undesirable location; and
at least one item that the first entity should not purchase.

20. The storage medium of claim 16, wherein the comparative result is either positive or negative.

21. The storage medium of claim 20, wherein the positive result is obtained if: the first entity was at a desired location for a desired duration, the first entity made a desirable purchase, the first entity burnt a pre-determined number of calories, or the first entity experienced an extended period of increased heart rate, and wherein the negative result is obtained if: the first entity was at an undesirable location for an undesirable duration, or the first entity made an undesirable purchase.

22. The storage medium of claim 20, wherein the balance in the digital wallet profile increases when the positive result is obtained, and wherein the balance in the digital wallet profile decreases when the negative result is obtained.

23. The storage medium of claim 16, wherein the instructions are either sent to a third party server to credit the digital wallet profile or sent to the digital wallet profile to credit the third party server.

24. (canceled)

25. (canceled)
